(19) United States
(12) Patent Application Publication
(10) Pub. No.: US 2009/0135101 A1
(43) Pub. Date: May 28, 2009

(54) PLASMA DISPLAY PANEL

(76) Inventor: Nobuyuki Takahashi, Miyazaki (JP)

Correspondence Address: MCDERMOTT WILL & EMERY LLP, 600 13TH STREET, N.W., WASHINGTON, DC, 20005-3096, US

(21) Appl. No.: 12/293,920

(22) PCT Filed: May 15, 2006
(86) PCT No.: PCT/JP2006/309665

§ 371 Date: Dec. 2, 2008

(51) Int. Cl. G09G 3/28

(52) U.S. Cl. 345/60

(57) ABSTRACT

A shielding film is partially formed so as to shield light emission of a reset discharge, whereby it becomes possible to reduce a black luminance while keeping a display luminance by the reset discharge and a stability of driving. A plasma display panel includes a front-side substrate in which, by arranging a plurality of display electrodes in a predetermined direction, a discharge slit is formed between the display electrodes; and a back-side substrate in which a plurality of address electrodes are arranged in a direction to intersect with the display electrodes, the front-side substrate and the back-side substrate being disposed to face each other to allow intersecting portions between the display electrodes and the address electrodes to form cells, so that a reset discharge for an address preparation is generated with the discharge slit, and a sustain discharge for a display is generated in the addressed cells. A shielding film is disposed on a light-emission area by the reset discharge of the front-face substrate.

### TECHNICAL FIELD

This present invention relates to a plasma display panel (hereinafter, referred to as a “PDP”), and more specifically relates to an electrode structure of a three-electrode surface-discharge-type PDP.

### BACKGROUND ART

The three-electrode surface-discharge-type PDP of an AC-drive type has been known as a conventional PDP. In this PDP, a large number of display electrodes capable of surface-discharging are formed on an inner face of one of substrates (for example, a front-side or a display-side substrate) in a horizontal direction, and a large number of address electrodes for use in selecting light-emitting cells are formed on an inner face of the other substrate (for example, a back-side substrate) in a direction intersecting with the display electrodes so that each of intersections between the display electrodes and the address electrodes is designed to form one cell (unit light-emitting area). One pixel is configured by three cells, that is, a red (R) cell, a green (G) cell and a blue (B) cell.

The PDP is manufactured through processes in which, after the front-side substrate and the back-side substrate thus formed have been aligned face to face with each other, with a peripheral portion being sealed, and then a discharge gas is sealed inside thereof.

The PDP having this structure is generally driven by an address-display separation system. In this driving, one frame is configured by a plurality of sub-frames (hereinafter, referred to as an “SF”) having respective weights of luminance. For example, eight sub-frames SF1 to SF8 having respective luminance ratios of 1:2:4:8:16:32:64:128 are prepared. Each SF is constituted by a reset period in which all cells are initialized (address preparation period), an address period in which a cell to emit light is selected and a sustain period in which a light emission of a selected cell is maintained. Moreover, by allowing the cell to emit light for a desired sub-frame period, a gradation display is performed.

In the above reset period, a reset discharge is generated by all the cells. In the address period, the cell to emit light is allowed to generate an address discharge. During the sustain period, a sustain discharge (maintaining discharge) is generated by the cell which has generated the address discharge.

As described above, in this PDP display, all the cells are allowed to generate a discharge for initialization during the reset period. For this reason, a portion corresponding a black display on a screen is also allowed to slightly emit light, and when this light emission by the reset discharge is large, a contrast of the screen is lowered. In the present invention, a luminance caused upon carrying out the black display on the screen is referred to as a black luminance (or a background luminance).

Conventionally, in order to reduce such black luminance, a method has been proposed in which a voltage having an obtuse waveform or a lamp waveform is applied as a voltage used for reset discharging, and the reset discharge having a weak discharge intensity is generated (see Patent Document 1).

### Patent Document 1: Published Unexamined Patent Application Hei 11 (1999)-352924

### DISCLOSURE OF THE INVENTION

### Problems to be Solved by the Invention

In this case, however, in order to improve the contrast, it is preferable to make the black luminance as low as possible.

In view of such a circumstance, the present invention has been devised, and present inventors have noted a difference in light-emission modes between the reset discharge and the sustain discharge, and have found that by partially forming a shielding film so as to shield light emission of the reset discharge, it becomes possible to reduce the black luminance while keeping a display luminance by the reset discharge and a stability of the driving.

### Means to Solve the Problems

The present invention provides a plasma display panel comprising: a front-side substrate in which, by arranging a plurality of display electrodes in a predetermined direction, a surface discharge slit is formed between the display electrodes; and a back-side substrate in which a plurality of address electrodes are arranged in a direction to intersect with the display electrodes, the front-side substrate and the back-side substrate being disposed to face each other to allow intersecting portions between the display electrodes and the address electrodes to form cells, so that a reset discharge for an address preparation is generated with the slit between the display electrodes, and a sustain discharge for a display is generated between the display electrodes in the addressed cells; characterized in that a shielding film is disposed on a light-emission area by the reset discharge of the front-face substrate.

### EFFECTS OF THE INVENTION

In accordance with the present invention, since the light emission by the reset discharge can be shielded, it is possible to achieve both of a reduction of the black luminance and an improvement of the display luminance, and the contrast of the display can be subsequently improved.

### BRIEF DESCRIPTION OF THE DRAWINGS

FIGS. 1(a) and 1(b) are explanatory drawings which show a structure of a PDP in accordance with the present invention.

FIGS. 2(a) to 2(c) are explanatory drawings which show a first embodiment of the present invention.

FIG. 3 is a drawing which shows a III-III line cross section of FIG. 2(a).

FIG. 4 is an explanatory drawing which shows a second embodiment of the present invention.

FIG. 5 is a drawing which shows a V-V line cross section of FIG. 4.

FIG. 6 is an explanatory drawing which shows a third embodiment of the present invention.

FIG. 7 is a drawing which shows a VII-VII line cross section of FIG. 6.

FIGS. 8(a) to 8(c) are explanatory drawings which show a Comparative Example in which no shielding film is placed.

FIG. 9 is a drawing which shows a IX-IX cross section of FIG. 8.

### REFERENCE NUMERALS

10 PDP
11 Front-side Substrate
12 Transparent electrode
13 Bus electrode
17, 24 Dielectric layer
19 Protective film
21 Back-side Substrate
28R, 28G, 28B Phosphor layer
29 Barrier rib
30 Discharge space
A Address electrode
L Display line
X,Y Display electrode

### BEST MODE FOR CARRYING OUT THE INVENTION

In the present invention, examples of a backside substrate and a frontside substrate include a substrate made of glass, quartz or ceramics and a substrate prepared by forming desired constituent elements, such as an electrode, an insulating film, a dielectric layer and a protective layer, on such substrates.

It is preferable to form a plurality of display electrodes on the frontside substrate in a predetermined direction, with a discharge slit being formed between the display electrodes. Moreover, it is also preferable to dispose a plurality of address electrodes on the backside substrate in a direction intersecting with the display electrodes.

The display electrodes and the address electrodes may be formed by using various kinds of known materials and methods in the art. Examples of materials used for these electrodes include transparent conductive materials, such as ITO and SnO₂, and metal conductive materials, such as Ag, Au, Al, Cu and Cr. Various methods conventionally known in the art can be used for forming the electrodes. For example, a thick-film-forming technique such as a printing may be used for forming the electrodes, or a thin-film-forming technique, such as a physical deposition method and a chemical deposition method, may be used for forming them. Examples of the thick-film-forming technique include such as a screen printing method. Examples of the physical deposition method in the thin-film-forming technique include such as a vapor deposition method or a sputtering method. Examples of the chemical deposition method include such as a thermal CVD method, a photo CVD method, or a plasma CVD method.

In the present invention, it is only necessary that a shielding film is disposed in a light emitting area associated with a reset discharge on the front-side substrate. This shielding film may be formed by using various known materials and methods in the art. For example, the shielding film may be formed by using a black pigment or a dark-colored dielectric material. In addition, in the case where no insulating property is required in a corresponding area, the shielding film may be formed by using the same material as that of the electrodes.

In the above structure, the shielding film is preferably placed in a center portion of a slit. Moreover, in the case where one of the display electrodes forms an anode upon generation of the reset discharge, the shielding film may be placed on an edge portion of the slit on one of the display electrode sides.

Moreover, the present invention relates to a plasma display panel in which the front-side substrate on which a plurality of the display electrodes used for a surface discharge are provided so as to be aligned in one direction and the back-side substrate on which a plurality of the address electrodes are provided in a direction intersecting with the display electrodes are placed face to face with each other, with each of intersecting portions between the display electrodes and the address electrodes being formed as a cell, and the reset discharge used for address preparation is generated between the display electrodes and the address electrodes, while a sustain discharge used for a display is generated between the display electrodes of the addressed cell, wherein the shielding film is disposed on the light emission area by the reset discharge of the front-side substrate.

Referring to Figs., the present invention will be described in detail by means of embodiments, hereinafter. Here, the present invention is not intended to be limited by these, and various modifications may be made therein.

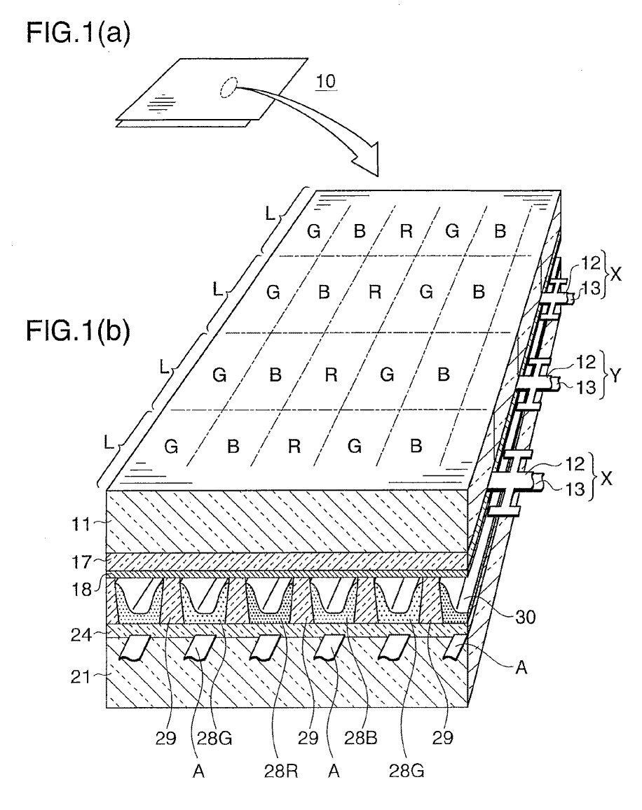

FIGS. 1(a) and 1(b) are explanatory drawings which show a structure of a PDP of the present invention. FIG. 1(a) is a general view, and FIG. 1(b) is a partially exploded perspective view. This PDP is a three-electrode surface-discharge-type PDP of an AC-drive type for color display.

This PDP 10 is configured by a front-side substrate 11 and a back-side substrate 21. As the front-side substrate 11 and the back-side substrate 21, for example, a glass substrate, a quartz substrate, a ceramic substrate or the like may be used.

On an inner side face of the front-side substrate 11, display electrodes X and display electrodes Y are disposed with equal intervals in horizontal directions. All gaps between the adjacent display electrodes X and the display electrodes Y form display lines L. Each of the display electrodes X and Y is configured by a transparent electrode 12 having a wide width, made of ITO, SnO₂ or the like, and a bus electrode 13 having a narrow width, made of metal, such as Ag, Au, Al, Cu, and Cr, as well as a laminated body (for example, Cr/Cu/Cr laminated structure) thereof or the like. Upon forming these display electrodes X and Y, the thick-film-forming technique, such as the screen-printing process, is used for Ag and Au, and the thin-film-forming technique, such as the vapor deposition method and the sputtering method, and an etching technique are used for the other materials so that a desired number of electrodes having a desired thickness, width and gap can be formed.

Here, in the present PDP, a PDP having a so-called ALIS structure in which the display electrodes X and the display electrodes Y are placed with equal intervals, with all the gaps between the adjacent display electrodes X and the display electrodes Y being allowed to form the display lines L, has been exemplified; however, the present invention may also be applied to a PDP having a structure in which paired display electrodes X and Y are placed with a distance (non-discharge gap) without generating any discharge being interposed therebetween.

On the display electrodes X and Y, a dielectric layer 17 is formed in a manner so as to cover the display electrodes X and Y. The dielectric layer 17 is formed by processes in which a low-melting-point glass paste is applied onto the front-side substrate 11 by using the screen-printing method and fired thereon. The dielectric layer 17 may be formed by forming a SiO₂ film using a plasma CVD method.

A protective film 18, used for protecting the dielectric layer 17 from damage due to collision of ions generated by discharge upon displaying, is formed on the dielectric layer 17. This protective film is made from MgO. The protective film may be formed by using the known thin-film forming process in the art, such as an electron beam vapor deposition method and the sputtering method.

On the inner side face of the back-side substrate 21, a plurality of address electrodes A are formed in a direction intersecting with the display electrodes X and Y on a plan view, and a dielectric layer 24 is formed in a manner so as to cover the address electrodes A. The address electrodes A generate an address discharge used for selecting cells to emit light at intersections with one kind of the display electrodes Y, and each of them is formed into a three-layer structure of Cr/Cu/Cr. These address electrodes A may also be formed by using another material, such as Ag, Au, Al, Cu and Cr. In the same manner as in the display electrodes X and Y, upon forming these address electrodes A, the thick-film-forming technique such as the screen-printing process is used for Ag and Au, and the thin-film-forming technique, such as the vapor deposition method and the sputtering method, and the etching technique are used for the other materials so that a desired number of electrodes having a desired thickness, width and gap can be formed. The dielectric layer 24 may be formed by using the same material and the same method as those of the dielectric layer 17.

A plurality of barrier ribs 29 having a stripe shape are formed on the dielectric layer 24 between the adjacent address electrodes A. Not limited to this shape, the shape of the barrier ribs 29 may have a mesh shape which divides a discharge space for each of the cells. The barrier ribs 29 are formed through a method, such as a sand blasting method, a printing method and a photoetching method. For example, in the sand blasting method, a glass paste, made from a low-melting-point glass frit, a binder resin, a solvent and the like, is applied onto the dielectric layer 24, and after the glass paste has been dried, cut particles are blasted onto a resulting glass paste layer, with a cutting mask having apertures of a barrier rib pattern being provided thereon, so that the glass paste layer exposed to the mask apertures is cut, and a resulting substrate is then fired; thus, the barrier ribs are formed. Moreover, in the photoetching method, in place of cutting by using the cut particles, a photosensitive resin is used as the binder resin, and after exposing and developing processes by the use of a mask, the resulting substrate is fired so that the barrier ribs are formed.

On side faces and a bottom face of a concave-groove-shaped discharge space between the barrier ribs 29, phosphor layers 28R, 28G and 28B corresponding to red (R), green (G) and blue (B) are formed. The phosphor layers 28R, 28G and 28B are formed through processes in which a phosphor paste containing a phosphor powder, a binder resin and a solvent is applied to inside of the discharge space having a concave groove shape between the barrier ribs 29 by using the screen-printing method or a method using a dispenser, and after these processes have been repeated for each of the colors, a firing process is carried out thereon. These phosphor layers 28R, 28G and 28B may also be formed by using a photolithographic technique in which a sheet-shaped phosphor layer material (so-called green sheet) containing the phosphor powder, the photosensitive material and the binder resin is used. In this case, a sheet having a desired color may be affixed onto an entire face of a display area on the substrate, and the sheet is subjected to exposing and developing processes; thus, by repeating these processes for each of the colors, the phosphor layers having the respective colors are formed in the corresponding gaps between the barrier ribs.

The PDP is manufactured through processes in which the front-side substrate 11 and the back-side substrate 21 are aligned face to face with each other in a manner so as to allow the display electrodes X, Y and the address electrodes A to intersect with each other, and a peripheral portion thereof is sealed, with a discharge space 30 surrounded by barrier ribs 29 being filled with a discharge gas formed by mixing Xe and Ne. In this PDP, the discharge space 30 at each of intersections between the display electrodes X, Y and the address electrodes A forms one cell (unit light-emitting area) which is a minimum unit of a display. One pixel is configured by three cells of R, B and G.

A displaying process is carried out in an address-display separation system. In this driving operation, one frame is configured by eight sub-frames SF1 to SF8 having respective weights of luminance. A ratio of luminance weights of the sub-frames SF1 to SF8 is set to be 1:2:4:8:16:32:64:128.

Here, each SF is constituted by a reset period in which all cells are initialized, an address period in which a cell to emit light is selected and a sustain period in which a light emission of a selected cell is maintained. Moreover, by allowing the cell to emit light for a desired sub-frame period, a gradation display is performed.

In the reset period, a reset voltage is applied across all the display electrodes X and Y so that the reset discharge is generated, and a discharging state of each cell is uniformly maintained.

In the address period, a scanning voltage is successively applied to the display electrodes Y, and during this time, by applying a voltage to a desired address electrode A, an address discharge is generated at an intersecting portion between the display electrode Y and the address electrode A so that a light emission cell is selected.

In the sustain period, by utilizing a wall charge formed on the display electrode Y of the cell by the address discharge, a sustain discharge (referred to also as a display discharge or a maintain discharge) is generated between the display electrode X and the display electrode Y.

The address discharge corresponds to a counter discharge between the address electrode A and the display electrode Y which faces each other in a vertical direction, and the sustain discharge is the surface discharge between the display electrodes X and Y disposed on a plane in parallel with each other.

### FIRST EXAMPLE

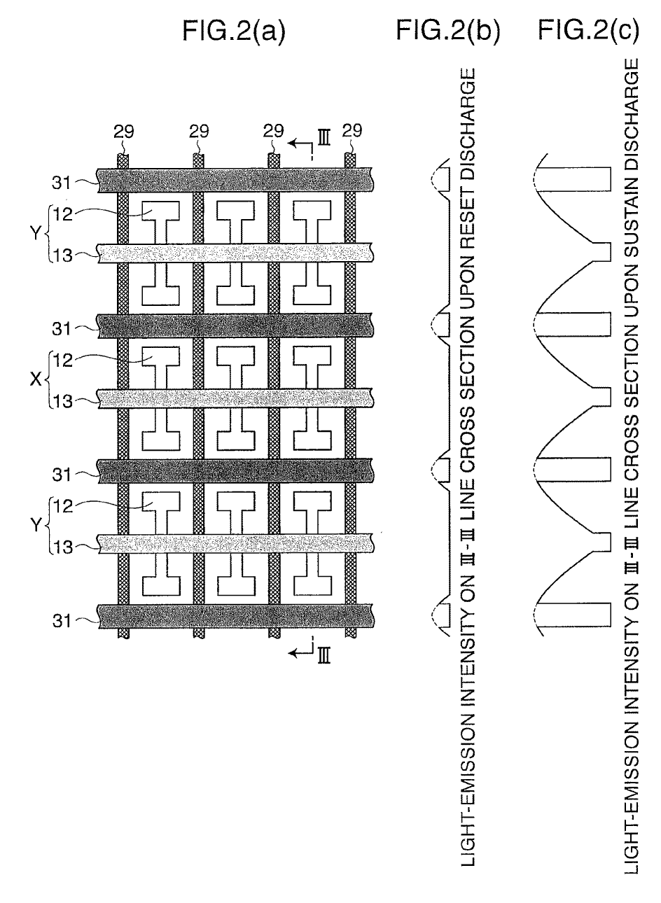

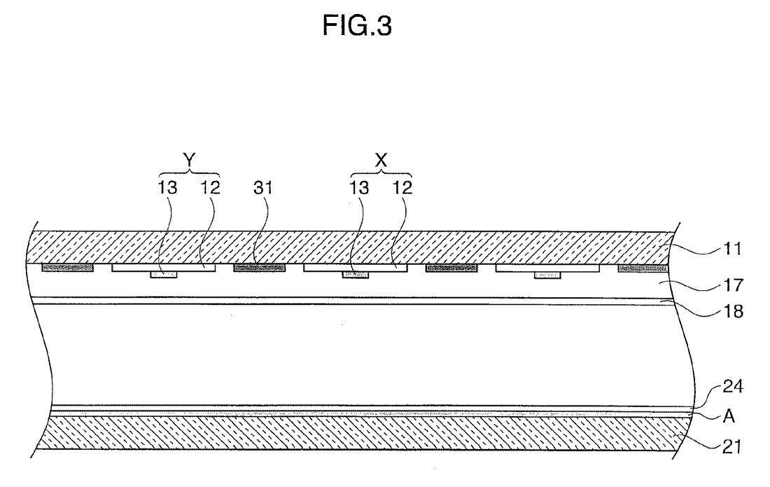

FIG. 2(a), FIG. 2(b), FIG. 2(c) and FIG. 3 are explanatory drawings which show a first example of the present invention. FIG. 2(a) shows a state in which the PDP on a plane is viewed. FIG. 2(b) shows a light emission intensity at the time of the reset discharge on a III-III line cross section of FIG. 2(a). As indicated by this Figure, the reset discharge occurs in a slit between the transparent electrodes. FIG. 2(b) shows a light emission intensity at the time of the sustain discharge on the III-III line cross section of FIG. 2(a). As indicated by this Figure, the sustain discharge occurs over the entire transparent electrode between bus electrodes. FIG. 3 shows the III-III line cross section of FIG. 2(a).

In this present Example, a dark-colored shielding film 31 is placed in a slit between the display electrode X and the display electrode Y of the front-side substrate 11. The light emission at the time of the reset discharge is shielded by the shielding film 31 over a portion indicated by a dotted line of FIG. 2(b). The light emission at the time of the sustain discharge is shielded over a portion indicated by a dotted line of FIG. 2(c). By shielding light in this manner, most of the light emission by the reset discharge is shielded so that shielded light of the light emission by the sustain discharge is suppressed to a low level. Therefore, a take-out efficiency of light from the discharge space to a display-side is made greater in the light emission at the time of the sustain discharge than in the light emission at the time of the reset discharge.

The shielding film 31 is formed by using the black pigment or the dark-colored dielectric material. Additionally, when placed on an area where no insulating property is required, the shielding film 31 may be formed by using the same material as that of bus electrode 13.

A layout of this shielding film is effective in a driving system where the surface discharge between the XY electrodes (between the display electrode X and the display electrode Y) is mainly utilized as the reset discharge. With this arrangement, the light emission at the time of the reset discharge is more effectively shielded, and the light emission at the time of the sustain discharge can be efficiently taken out so that the display luminance can be improved, while a black luminance is reduced.

### SECOND EXAMPLE

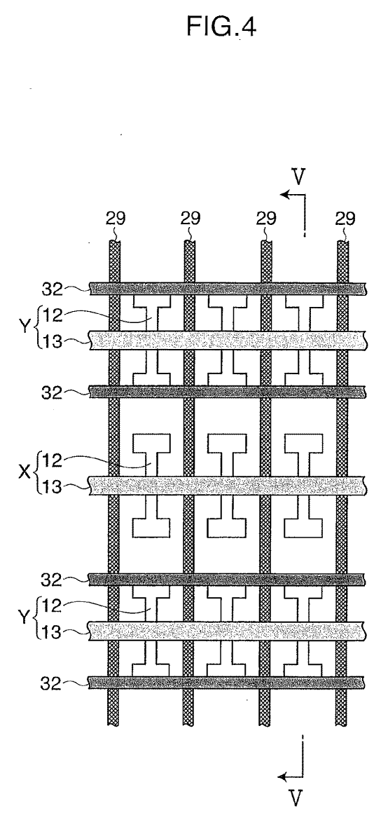

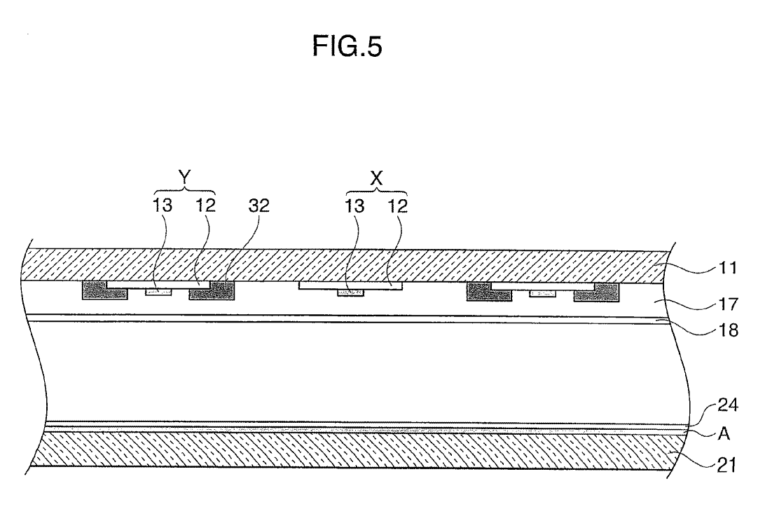

FIG. 4 and FIG. 5 are explanatory drawings which show a second example of the present invention. FIG. 4 shows the state in which the PDP on a plane is viewed. FIG. 5 shows a V-V line cross section of FIG. 4.

In this present Example, a shielding film 32 is disposed at a slit edge portion on the display electrode Y side of the front-side substrate 11. This layout is effective in the case when the surface discharge, generated with either the display electrode X or the display electrode Y being used as the anode, is mainly utilized as the reset discharge. In this present Example, since a strong reset discharge is generated on the display electrode Y side of the anode, the reset discharge can be effectively light-shielded by the shielding film 32. Contrary to this, in the case when the display electrode X side is used as the anode, the shielding film 32 is disposed at a slit edge portion on the display electrode X side.

With this layout of the shielding film, the reset discharge provides the light emission which is biased toward either one of the display electrode X or the display electrode Y from the slit center portion. With this arrangement, the light emission at the time of the reset discharge can be efficiently shielded, while the sustain discharge can be efficiently taken out, so that the display luminance can be improved, with the black luminance being reduced.

### THIRD EXAMPLE

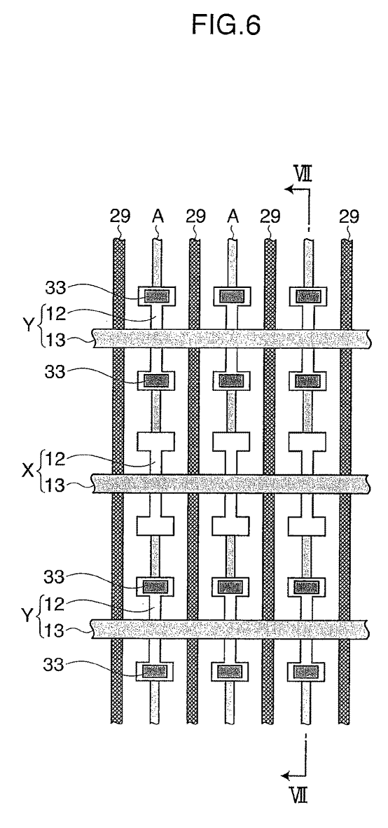

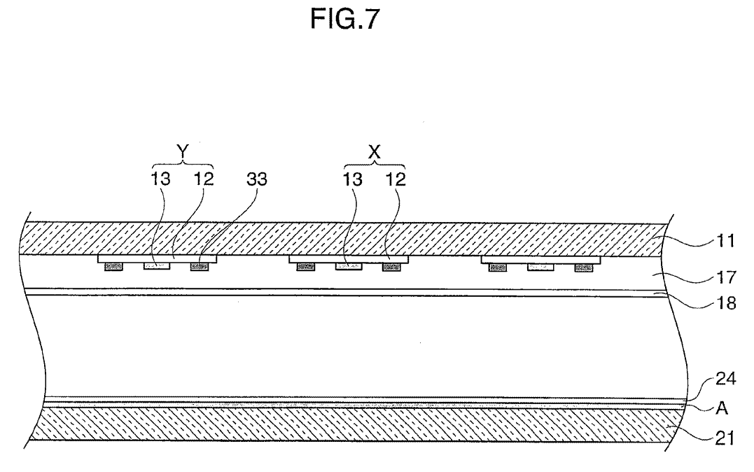

FIG. 6 and FIG. 7 are explanatory drawings which show a third example of the present invention. FIG. 6 shows the state in which the PDP on a plane is viewed. FIG. 7 shows a VII-VII line cross section of FIG. 6.

In this present Example, a shielding film 33 is disposed at an intersecting area between the address electrode A and the display electrode Y on the front-side substrate 11.

This layout makes it possible to effectively light-shield the reset discharge in a driving system in which the counter discharge between the address electrode A and the display electrode Y is mainly utilized as the reset discharge. Contrary to this, in a driving system in which a counter discharge between the address electrode A and the display electrode X is utilized as the reset discharge, the shielding film 33 is disposed at an intersecting area between the address electrode A and the display electrode X on the front-side substrate 11.

That is, this layout of the shielding film is effectively used for the driving system in which the counter discharge between the AY electrodes (between the address electrode A and the display electrode X) or the counter discharge between the AX electrodes (between the address electrode A and the display electrode X) is mainly utilized as the reset discharge. With this arrangement, the light emission at the time of the reset discharge can be efficiently shielded, while the sustain discharge can be efficiently taken out so that the display luminance can be improved, with the black luminance being reduced. With this arrangement, the light emission at the time of the reset discharge can be efficiently shielded, while the sustain discharge can be efficiently taken out so that the display luminance can be improved, with the black luminance being reduced.

### COMPARATIVE EXAMPLE

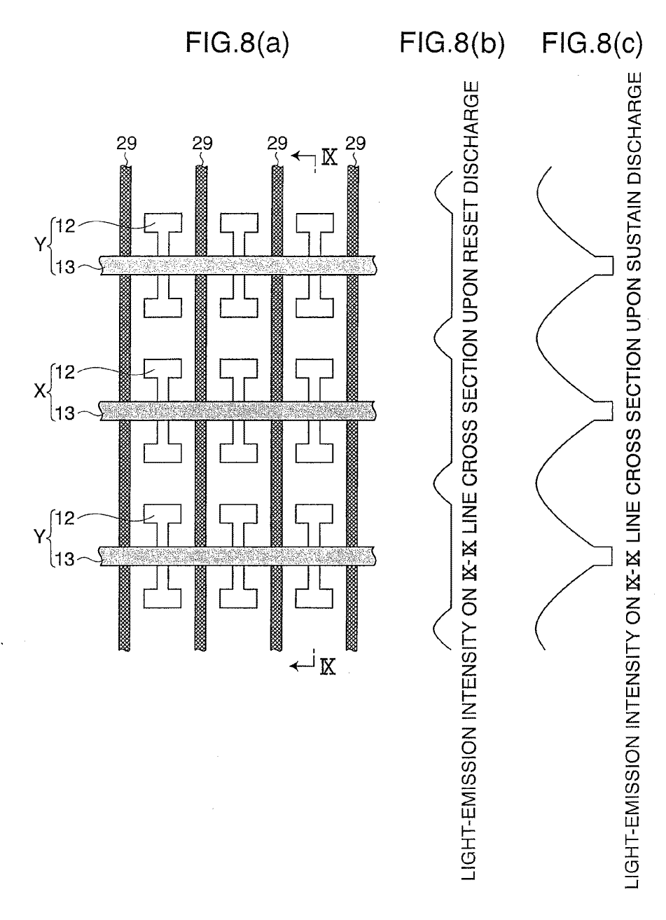

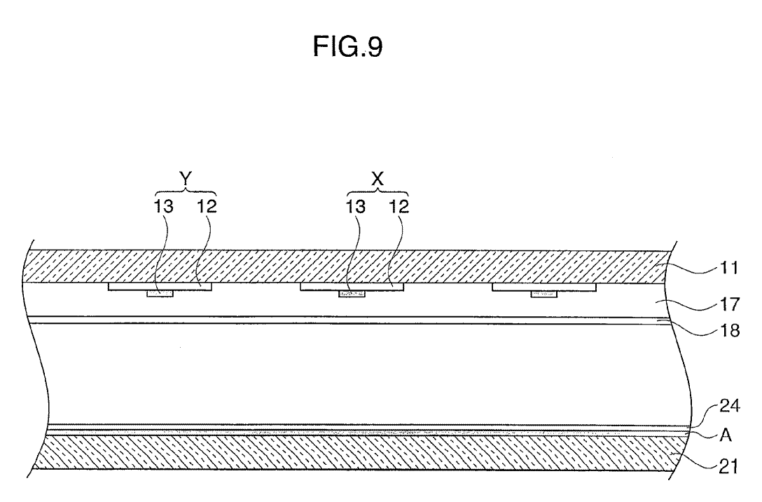

FIG. 8(a), FIG. 8(b), FIG. 8(c) and FIG. 9 are explanatory drawings which show a comparative example in which the shielding film of the present invention is not placed. FIG. 8(a) shows the state in which the PDP on a plane is viewed. FIG. 8(b) shows a light emission intensity at the time of the reset discharge on a IX-IX line cross section of FIG. 8(a). FIG. 8(c) shows a light emission intensity at the time of the sustain discharge on a IX-IX line cross section of FIG. 8(a). FIG. 9 shows the IX-IX line cross section of FIG. 8(a).

In the PDP of the AC type, the black luminance is dependent on light-emission luminance of the reset discharge, and the display luminance is dependent on light-emission luminance of the sustain discharge so that each light-emission luminance is determined. For display performance, it is desirable to reduce the black luminance, with the display luminance being increased.

In general, the reset discharge is exerted by applying a voltage waveform corresponding to an obtuse wave (a voltage pulse having a voltage which gradually rises or drops) across the XY electrodes (across the display electrode X and the display electrode Y), across the AY electrodes, or across the AX electrodes so as to generate a discharge. Therefore, in the reset discharge caused by the surface discharge across the XY electrodes, the light emission is exerted in a place limited to a narrow area from one of ends of the electrode to a center portion between the electrodes (see FIG. 8(b)). Moreover, in a similar manner, in the reset discharge caused by the counter discharge across the AY electrodes, the light emission is exerted in a place limited to a narrow area centered on the intersecting area between the AY electrodes.

In contrast, since the sustain discharge is exerted by applying a voltage waveform corresponding to a rectangular wave across the XY electrodes, the light emission is generated over a wide area covering the entire discharge space between the bus electrodes (see FIG. 8(c)).

That is, the light emission of the sustain discharge is one which expands over the entire electrode faces, while the light emission of the reset discharge caused by the obtuse wave is one limited to a gap between the end portions of the electrodes (slit area).

In the present invention, these two different modes of light emission are utilized. When FIG. 8(c) and FIG. 2(c) are compared with each other, the luminance of the sustain discharge is greater in the case where no shielding film of the present invention is used. However, from the viewpoint of a luminance difference between the sustain discharge and the reset discharge, the luminance difference becomes greater with the shielding film of the present invention in comparison with the structure without the shielding film. Therefore, by placing the shielding film of the present invention, it is possible to improve a contrast of the screen.

In this manner, by using a panel structure in which the shielding film of the present invention is disposed, it is possible to effectively shield a reset light emission, while maintaining a high take-out efficiency of a sustain light emission, by a light-shielding function of the shielding film.

As described above, in accordance with the present Examples, by placing the shielding film on an area which is allowed to emit light by the reset discharge, it is possible to satisfy both of a reduction of the black luminance and an improvement of the display luminance, and consequently to improve the contrast of the screen. Thus, the background luminance can be reduced without a reduction in reset performance (without narrowing a driving margin).

1. A plasma display panel comprising:
a front-side substrate in which, by arranging a plurality of display electrodes in a predetermined direction, a surface discharge slit is formed between the display electrodes; and
a back-side substrate in which a plurality of address electrodes are arranged in a direction to intersect with the display electrodes, the front-side substrate and the back-side substrate being disposed to face each other to allow intersecting portions between the display electrodes and the address electrodes to form cells, so that a reset discharge for an address preparation is generated with the slit between the display electrodes, and a sustain discharge for a display is generated between the display electrodes in the addressed cells;
characterized in that a shielding film is disposed on a light-emission area by the reset discharge of the front-face substrate.

2. The plasma display panel according to claim 1, wherein the shielding film is disposed in a center portion of the slit.

3. The plasma display panel according to claim 1, wherein the shielding film is disposed at an edge portion of the slit of display electrodes on one side, and the display electrodes on one side form an anode upon generation of the reset discharge.

4. A plasma display panel comprising:
a front-side substrate in which a plurality of display electrodes used for a surface discharge are provided so as to be aligned in one direction; and
a back-side substrate in which a plurality of address electrodes are provided in a direction to intersect with the display electrodes, each of intersecting portions between the display electrodes and the address electrodes being formed as a cell, so that a reset discharge for an address preparation is generated between the display electrode and the address electrode, and a sustain discharge for a display is generated between the display electrodes in the addressed cells;
characterized in that a shielding film is disposed on a light-emission area by the reset discharge of the front-face substrate.
